(19) United States
(12) Patent Application Publication
(10) Pub. No.: US 2003/0217610 A1
(43) Pub. Date: Nov. 27, 2003

(54) Electric actuator

(75) Inventors: Shigekazu Nagai, Adachi-ku (JP); Toru Sugiyama, Abiko-shi (JP); Masahiko Someya, Ryugasaki-shi (JP)

Correspondence Address: PAUL A. GUSS, PAUL A. GUSS ATTORNEY AT LAW, 775 S 23RD ST FIRST FLOOR SUITE 2, ARLINGTON, VA, 22202

(73) Assignee: SMC Kabushiki Kaisha, Tokyo (JP)

(21) Appl. No.: 10/442,067

(22) Filed: May 21, 2003

(30) Foreign Application Priority Data
May 27, 2002 (JP) 2002-152931

(51) Int. Cl. F16C 29/00

(52) U.S. Cl. 74/89.2; 74/490.04

(57) ABSTRACT

An electric actuator has an air guide which communicates a space via ventilating holes formed through an actuator body. The electric actuator includes a fan unit provided with an impeller for forcibly suctioning the air in the space of the actuator body by a motor. The air suctioned by the fan unit is discharged from a discharge port at an end of the air guide.

### BACKGROUND OF THE INVENTION

1. Field of the Invention

The present invention relates to an electric actuator which makes it possible to linearly reciprocate a slider along an actuator body.

2. Description of the Related Art

An electric actuator is used to transport a workpiece carried on a slider to a predetermined position by displacing the slider along an actuator body by a motor.

The conventional electric actuator as described above is constructed as follows. For example, a guide means and a converting means such as a ball screw shaft for converting the rotary driving force of the motor into the rectilinear motion are arranged in the internal space of the actuator body. The rectilinear motion is transmitted to the slider via a slit formed in the axial direction of the actuator body.

For example, when the conventional electric actuator is used in a clean room in which cleanness is required, it is necessary to provide some suction means such as an ejector or a vacuum pump for evacuating air from the internal space of the actuator body so that the dust generated in the actuator body is prevented from diffusing outside of the actuator body.

When the air in the internal space of the actuator body is suctioned by the suction means, the air in the actuator body containing the dust or the like is discharged to the outside of the clean room, and it is possible to maintain the cleanness in the clean room.

However, when a plurality of electric actuators are assembled in a semiconductor production apparatus or the like installed in a clean room so that their movable sections are displaceable multiaxially, it is difficult to install suction tubes having large diameters along the displacement directions of the movable sections. Further, it is difficult to secure a sufficient amount of suction, because the suction tubes are long.

Furthermore, when the ejector is used as the suction means, it is necessary to provide an air supply source for supplying the air to the ejector. On the other hand, when the vacuum pump is used as the suction means, the cost is high.

### SUMMARY OF THE INVENTION

A general object of the present invention is to provide an electric actuator which does not require a suction tube, so that the production cost is not raised, and which makes it possible to realize the cleanness in the limited spaces just over and just under a reciprocating slider.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view illustrating an electric actuator according to an embodiment of the present invention;

FIG. 2 is a see-through perspective view illustrating a driving-force transmitting mechanism and a fan unit of the electric actuator shown in FIG. 1;

FIG. 3 is a longitudinal sectional view taken in the axial direction illustrating the electric actuator shown in FIG. 1;

FIG. 4 is, with partial omission, an exploded perspective view illustrating a joining portion between an actuator body and the fan unit;

FIG. 5 is a schematic arrangement of a clean room in which the electric actuator shown in FIG. 1 is used; and

FIG. 6 is a perspective view in which the electric actuator shown in FIG. 1 is assembled to an apparatus for displacement in directions along two axes.

### DESCRIPTION OF THE PREFERRED EMBODIMENTS

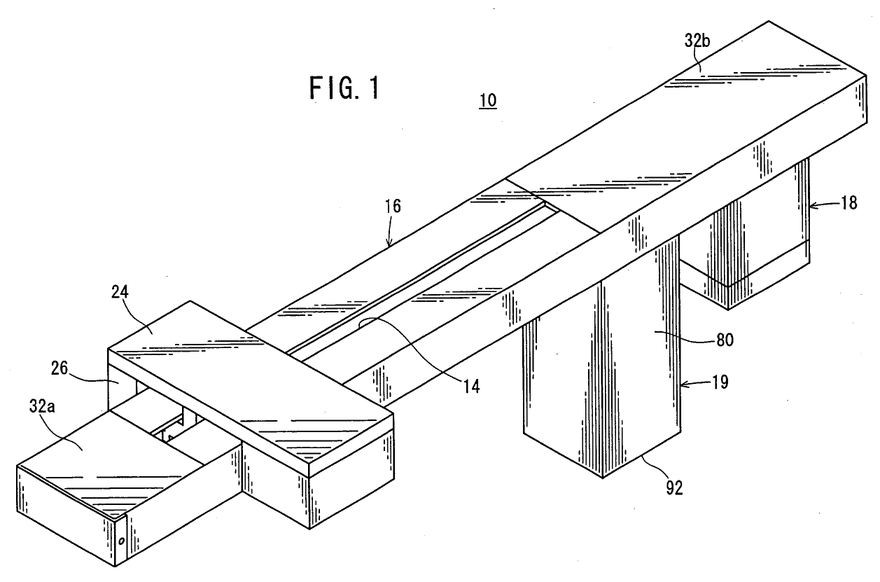

With reference to FIG. 1, reference numeral 10 indicates an electric actuator according to an embodiment of the present invention.

The electric actuator 10 comprises an actuator body 16, a rotary driving section (driving section) 18, and a fan unit 19. The actuator body 16 is a rectangular cylinder having two pairs of facing surfaces formed substantially in parallel to one another and has a linear slit 14 formed through an upper surface of the rectangular cylinder extending by a predetermined length in the axial direction. The rotary driving section (driving section) 18 is connected to one end of the actuator body 16. The fan unit 19 is disposed adjacently to the rotary driving section 18 and is connected to a bottom surface of the actuator body 16.

In this arrangement, the actuator body 16 is a flat rectangular cylinder in which the horizontal dimension is larger than the height to be used in an environment in which the height dimension is restricted.

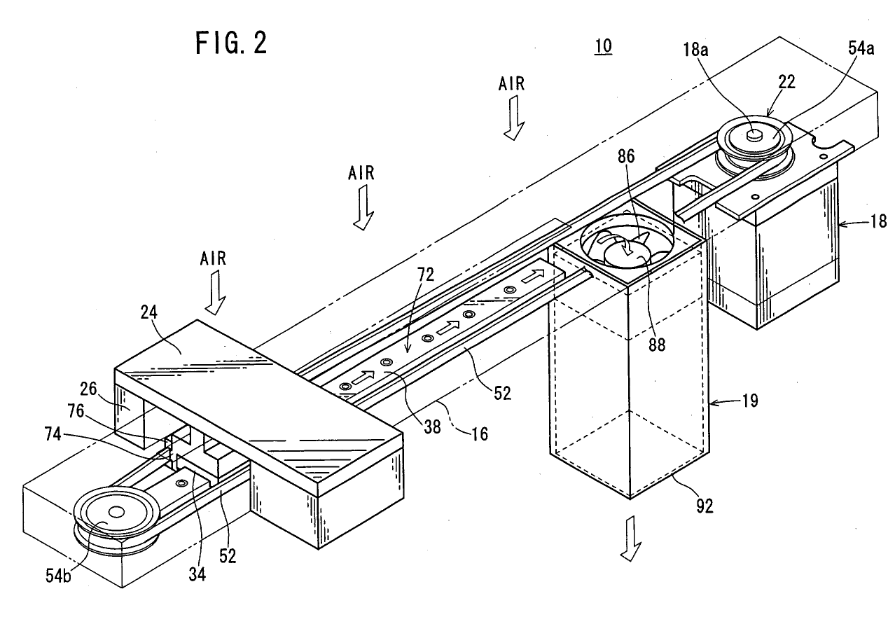

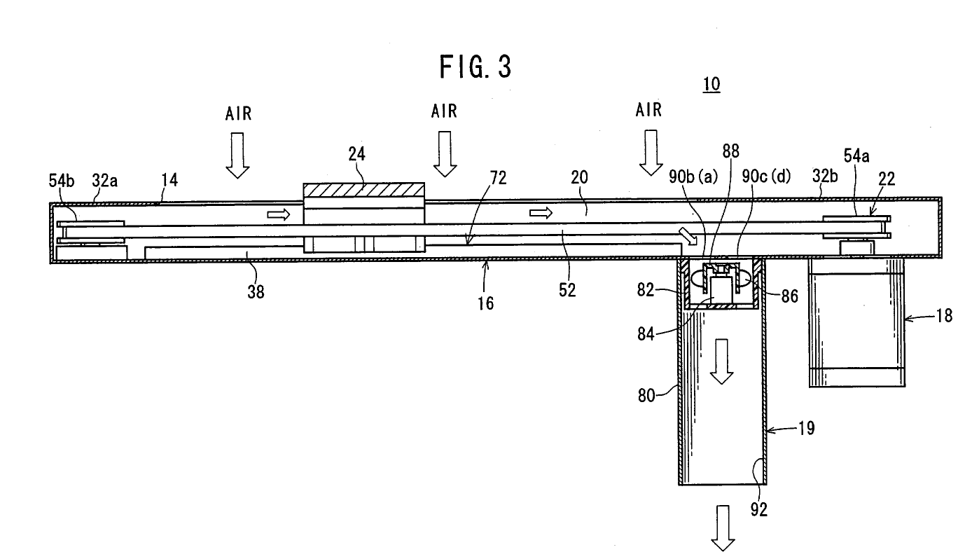

The electric actuator 10 further includes a driving-force transmitting mechanism 22 (see FIGS. 2 and 3) and a slider 24. The driving-force transmitting mechanism 22 is arranged in a space 20 (see FIG. 3) surrounded by the actuator body 16 and converts the rotary driving force of the rotary driving section 18 into the rectilinear motion to be transmitted. The slider 24 is exposed through the slit 14 and reciprocates in the axial direction of the actuator body 16 in accordance with the rectilinear motion transmitted by the driving-force transmitting mechanism 22.

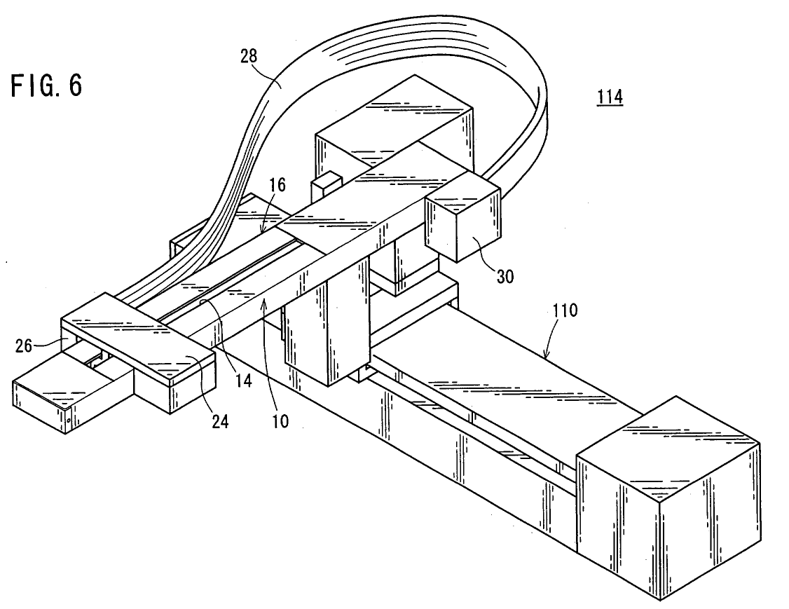

A first connector block 26 is connected to the side of the slider 24. A band-shaped cable 28, which is bendable substantially in the horizontal direction, has one end connected to the first connector block 26. The other end of the cable 28 is connected to a second connector block 30 which is connected to an end of the actuator body 16 (see FIG. 6).

The actuator body 16 is formed, for example, by extrusion with a metal material such as aluminum or aluminum alloy. As shown in FIG. 1, a pair of end covers 32a, 32b are attached to both ends of the actuator body 16 for closing the openings of the rectangular cylinder.

As shown in FIG. 2, a pair of pulleys 54a, 54b are arranged in the space 20 of the actuator body 16. A timing belt (belt member) 52 runs over the pulleys 54a, 54b. The pair of pulleys 54a, 54b are spaced from each other by a predetermined distance in the axial direction. The driving pulley 54a is rotatably attached to a drive shaft 18a of the rotary driving section 18. The other driven pulley 54b is rotatably supported by a pair of unillustrated disk-shaped bearing members and a shaft. The pair of pulleys 54a, 54b and the timing belt 52 function as the driving-force transmitting mechanism.

A guide mechanism 72 is provided in the space 20 of the actuator body 16 for linearly displacing the slider 24 along the slit 14. The guide mechanism 72 comprises a linear guide rail 38 fixed to a wall surface (bottom surface) in the space 20 of the actuator body 16, and a guide block 34 provided displaceably together with the slider 24 and sliding along the linear guide rail 38.

As shown in FIG. 2, the timing belt 52 is interposed between a fixing block 76 and a bent section 74 formed on the side of the slider 24. When the timing belt 52 running over the pair of driving and driven pulleys 54a, 54b is rotated in a predetermined direction, the slider 24 is displaced linearly together with the timing belt 52.

As shown in FIG. 3, the fan unit 19 includes a rectangular cylindrical air guide 80, a motor (rotary driving source) 84, and an impeller 88. The air guide 80 is connected to the bottom surface portion of the actuator body 16 by unillustrated screw members so that the air guide 80 is positioned substantially perpendicularly to the axis of the actuator body 16. The motor 84 is fixed in the air guide 80 by a bracket 82 at a position adjacent to the actuator body 16. The impeller 88 is connected to a rotary shaft of the motor 84 and has a plurality,of impeller blades 86 to rotate in the circumferential direction about the center of the rotary shaft by the motor 84.

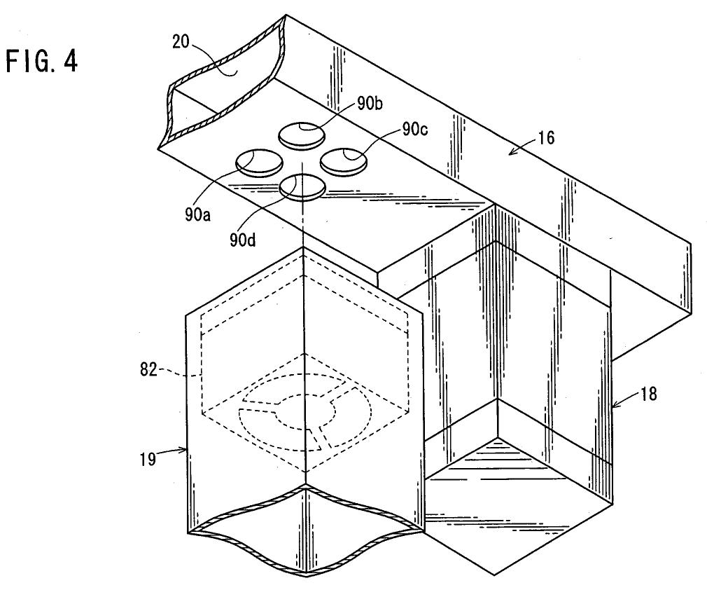

As shown in FIG. 4, four circular ventilating holes 90a through 90d are formed penetratingly through the bottom surface of the actuator body 16 to which the air guide 80 is connected. When the impeller 88 is rotated in a predetermined direction by driving the motor 84 of the fan unit 19, the air in the space 20 of the actuator body 16 is suctioned into the air guide 80 through the ventilating holes 90a through 90d. The suctioned air is discharged from a discharge port 92 of the air guide 80.

The electric actuator 10 according to the embodiment of the present invention is basically constructed as described above. Next, its operation, function, and effect will be explained.

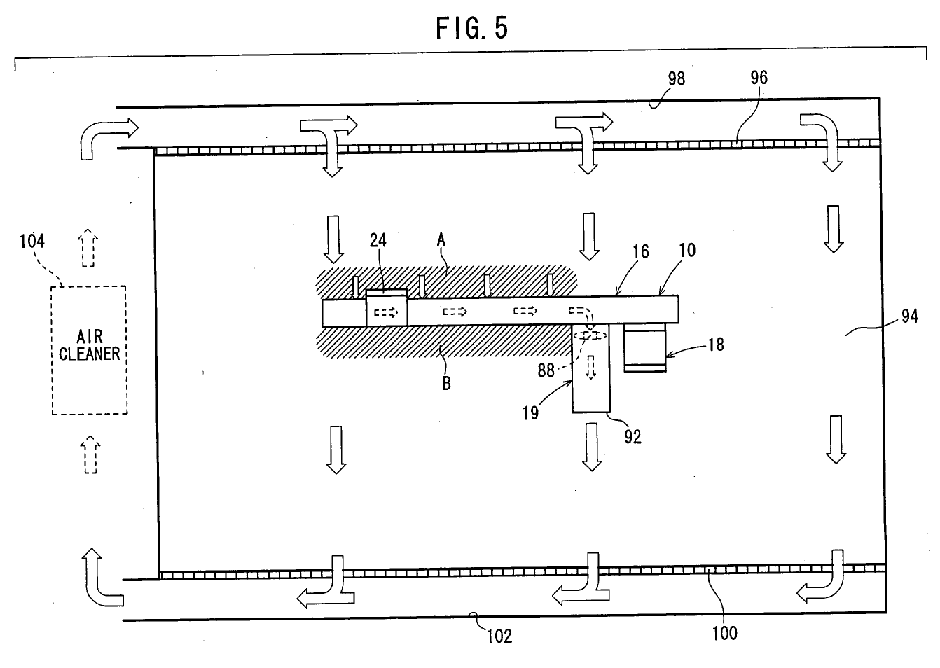

At first, FIG. 5 shows a schematic arrangement in a clean room 94 in which the electric actuator 10 according to the embodiment of the present invention is used. The clean room 94 is provided with a downflow duct 98, a duct 102, and an air cleaner 104. The downflow duct 98 is provided on the ceiling and is formed with a large number of air feed ports 96 for feeding the clean air. The duct 102 is formed on the floor and is formed with a large number of air suction ports 100. The air cleaner 104 removes the dust contained in the air fed from the duct 102 and feeds the clean air to the downflow duct 98.

In this arrangement, the air fed from the downflow duct 98 on the ceiling flows downwardly substantially in the vertical direction toward the duct 102 on the floor. The air is suctioned from the air suction ports 100 into the duct 102. The air passes through the air cleaner 104, and the air is returned to the downflow duct 98 again to circulate continuously. Therefore, the clean air flows in the clean room 94 in the direction indicated by the arrows shown in FIG. 5. The flows of the air are divided by the electric actuator 10 into the upstream and downstream sides in the clean room 94.

In this situation, when an unillustrated power source is energized, the drive shaft 18a of the rotary driving section 18 is rotated in a predetermined direction. The driving pulley 54a rotatably attached to the drive shaft 18a of the rotary driving section 18 is rotated in the predetermined direction, and the timing belt 52 running over the driving pulley 54a and the driven pulley 54b is rotated. Therefore, the slider 24 is displaced linearly along the slit 14 by the timing belt 52 which is interposed between the bent section 74 and the fixing block 76.

When the polarity of the current supplied to the rotary driving section 18 is reversed from the above, then the timing belt 52 is rotated in the direction opposite to the above, and the slider 24 can be displaced in the direction opposite to the above.

In the embodiment of the present invention, the impeller 88 is rotated in the predetermined direction by driving the motor 84 of the fan unit 19. Accordingly, the air in the space 20 of the actuator body 16 is suctioned into the air guide 80 via the ventilating holes 90a through 90d, and the suctioned air can be discharged from the discharge port 92 of the air guide 80.

Therefore, in the embodiment of the present invention, it is possible to forcibly suction by energizing the fan unit 19, the air in the space 20 of the actuator body 16 containing the dust or the like generated by the sliding displacement of the guide block 34 along the linear guide rail 38 and the dust or the like generated by the meshing action between the pair of pulleys 54a, 54b and the timing belt 52. Accordingly, it is possible to appropriately discharge the air through the discharge port 92 of the air guide 80 out of the area disposed outside the actuator body 16 in which the cleanness is required.

That is, the area where the cleanness is required includes a space A just over the reciprocating slider 24 (on the upstream side of the air flow in the clean room 94), and a space B just under the slider 24 (on the downstream side of the air flow in the clean room 94). The fan unit 19 is used to suction the air in the space 20 of the actuator body 16 and the air in the space A just over the slider 24 through the slit 14 formed through the upper surface of the actuator body 16 (on the upstream side of the air flow in the clean room 94). The air suctioned by the fan unit 19 is discharged from the discharge port 92 of the air guide 80 which is disposed at the position lower than the space B just under the slider 24 (on the downstream side of the air flow in the clean room 94).

As a result, it is possible to retain the cleanness in the predetermined space A and space B where the cleanness is required just over and just under the slider 24, by utilizing the airflow downwardly from the downflow duct 98 of the clean room 94.

In the embodiment of the present invention, it is unnecessary to perform, for example, any piping operation to install the suction tube. Only a power source cord is provided for supplying the electric power to the motor 84 of the fan unit 19. Further, it is unnecessary to provide any suction means such as the ejector and the vacuum pump. Accordingly, it is possible to reduce production cost.

In the embodiment of the present invention, the fan unit 19 is used to directly suction the interior of the space 20 of the actuator body 16. Therefore, it is unnecessary to use any unillustrated filter, and it is possible to reduce discharge resistance. It is possible to suction a large amount of the airflow as compared with the case when the filter is provided.

In the embodiment of the present invention, it is unnecessary to perform any maintenance which would be otherwise performed, for example, due to the clog-up of the filter, because the filter is not provided. It is possible to reduce maintenance cost.

As shown in FIG. 6, the electric actuator 10 according to the embodiment of the present invention may be integrally assembled to another actuator 110 to constitute an apparatus 114 capable of moving in the directions of two axes of X and Y. Alternatively, still another unillustrated actuator, which moves in the Z axis direction, may be additionally provided to constitute an apparatus capable of moving in the directions of three axes of X, Y, and Z.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. An electric actuator comprising:
an actuator body with a slit extending by a predetermined length in an axial direction;
a driving section connected to an end of said actuator body;
a driving-force transmitting mechanism arranged in a space surrounded by said actuator body for transmitting driving force of said driving section;
a slider reciprocating along said slit of said actuator body by said driving force transmitted by said driving-force transmitting mechanism; and
a fan unit connected to said actuator body and provided with an impeller for forcibly suctioning air in said space of said actuator body by a rotary driving source.

2. The electric actuator according to claim 1, wherein said fan unit has an air guide communicating said space via a ventilating hole formed through said actuator body, and suctioned air is discharged from a discharge port which is formed at an end of said air guide.

3. The electric actuator according to claim 1, wherein said electric actuator is used in a clean room in which clean air flows from a ceiling to a floor.

4. The electric actuator according to claim 1, wherein said actuator body is a rectangular cylinder which has two pairs of facing surfaces, and said driving-force transmitting mechanism comprises a belt member running over a pair of pulleys spaced from each other by a predetermined distance.

5. The electric actuator according to claim 1, wherein a first connector block is connected to a side of said slider, a second connector block is connected to an end of said actuator body, one end of a cable which is bendable in a horizontal direction is electrically connected to said first connector block, and the other end of said cable is electrically connected to said second connector block.

6. The electric actuator according to claim 4, wherein a guide mechanism is arranged in said space of said actuator body, and said guide mechanism displaces said slider linearly along said slit.
